(19) United States
(12) Patent Application Publication
(10) Pub. No.: US 2007/0063830 A1
(43) Pub. Date: Mar. 22, 2007

(54) Vehicle instrumentation

(75) Inventors: Timothy J. Yerdon, Plymouth, MI (US); Royce D. Channey, Highland Park, MI (US); Henry L. Pope, Redford, MI (US)

Correspondence Address: BRINKS HOFER GILSON & LIONE, P.O. BOX 10395, CHICAGO, IL, 60610, US

(73) Assignee: Visteon Global Technologies, Inc.

(21) Appl. No.: 11/228,146

(22) Filed: Sep. 16, 2005

(51) Int. Cl. B60Q 1/00

(52) U.S. Cl. 340/461

(57) ABSTRACT

An information display assembly for an automotive vehicle includes an instrument cluster and a mounting unit. The mounting unit supports the instrument cluster in a forward interior location of the vehicle. The instrument cluster is orientable with respect to the mounting unit for optimal viewing by an operator of the vehicle. The internal location of the mounting unit is selectable by the operator.

### FIELD

The present invention relates, generally, to vehicle instrumentation clusters, and more particularly to an apparatus for optional relocation of the vehicle driver information systems.

### BACKGROUND

Typically, motor vehicles are equipped with instrument panels and instrument clusters, which are designed to present various electrical and mechanical instruments that provide information on a status of the vehicle. These various instruments are typically arranged as a set or sets of gauges, dials, and display screens.

Generally, the instrument cluster is embedded in a similar location on a instrument panel or console, and contained inside of a module or package. However, this arrangement creates complexity and cost to manufacture as instrument panel tooling needs to be created to support a manufactured vehicle model and changed with new design iterations.

The instrument cluster is typically configured in a predetermined arrangement before leaving a manufacturing plant, whether as standard or as a purchaser pre-selected equipment of the vehicle. However, car enthusiasts have been known to seek post-manufacturing instrumentation that indicate or emphasize particular vehicle parameters, such as parameters that are relevant to racing or to off-road situations.

The location of the instrument cluster is strategically paramount so as to be visible to a vehicle operator and readable while the vehicle is in motion. This location of the instrument panel vehicle operator has traditionally been positioned just below the operator's line of sight on the road ahead through the front windshield, and as part of the dashboard or instrument panel. However, this instrument cluster has generally been partially obstructed from the operator's view by the steering wheel, positioned between the operator and the instrument panel.

Moreover, the operator's eyes can require adjustment time when shifting attention from the road ahead to the instrument cluster, and vice-versa. This adjustment of the operator's eyes between the road ahead and the instrument cluster can increase in difficulty and in time when the outside light is sensibly different than the light inside the vehicle. This repeated shifting of attention and refocusing of eyes can reduce the safe operation of the vehicle.

Accordingly, there exists a need to adapt the location of the instrument cluster that minimizes the complexity and cost needed for the manufacturing tooling and assembly/service related to the integration of vehicle driver information systems into the instrument cluster, and reduces the operator's distraction from the driving operation of the vehicle.

### SUMMARY

The present invention is defined by the appended claims. This description summarizes some aspects of the present embodiments and should not be used to limit the claims.

One object is to disclose an information display assembly for an automotive vehicle. The information display assembly has an instrument cluster, and a mounting unit. The mounting unit supports the instrument cluster at a forward location of an interior of the vehicle selectable by an operator.

One advantageous feature is that the instrument cluster is orientable with respect to the mounting unit for optimal viewing by the operator.

Another advantageous feature of the mounting unit is configured to hold the adjusted position of the instrument cluster until readjusted by the operator.

Another still advantageous feature is that the instrument cluster has at least one display instrument that is partially transparent to minimize an interference with a forward line of sight of the operator.

Illustrative and exemplary embodiments of the invention are described in further detail below with reference to and in conjunction with the figures.

### BRIEF DESCRIPTION OF THE DRAWINGS

The invention, including its construction and method of operation, is illustrated diagrammatically in the drawings, in which:

FIG. 1 is a perspective view of an embodiment of an information display assembly for an automotive vehicle in accordance with the present invention;

FIGS. 2A and 2B are front and back elevational views of an instrument cluster of the information display assembly of FIG. 1;

FIG. 3 is a side elevational view of a mounting unit supporting the information display assembly of FIG. 1; and

FIG. 4 is a front view of an alternate embodiment of the information display assembly constructed in accordance with the present invention.

### DETAILED DESCRIPTION OF THE DRAWINGS

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

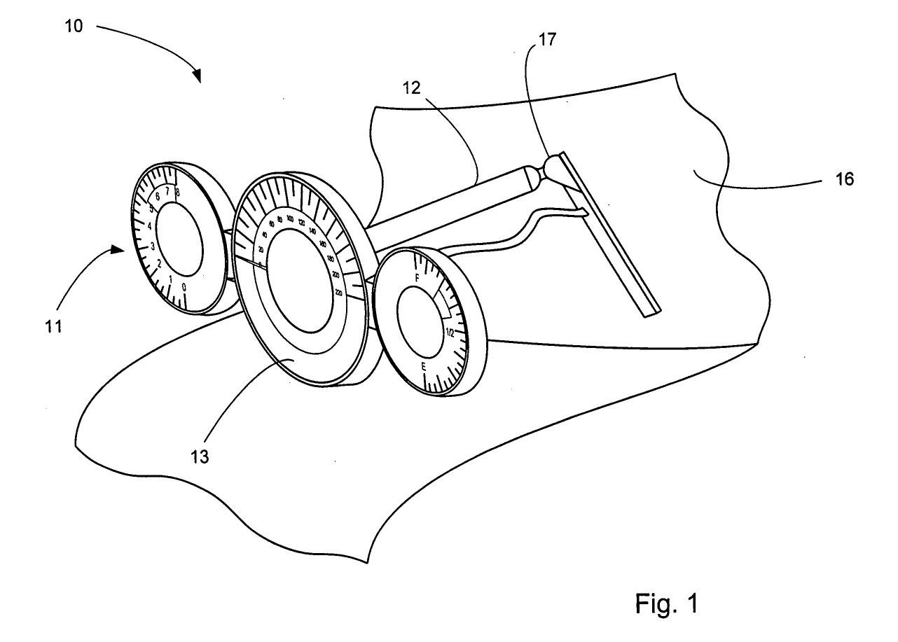

Turning now to the drawings, and particularly to FIG. 1, an information display assembly embodying the principles of the present invention is illustrated and generally designated at 10. The information display assembly 10 comprises an instrument cluster 11, and a mounting unit 12 for supporting the instrument cluster 11. The instrument cluster 11 includes a front portion 13 comprising gauges, dials, and displays, and a back portion (not shown) for detachably connecting the instrument cluster 11 to the mounting unit 12 and for detachably receiving or engaging an electronic wire harness 15. Without loss of generality, the gauges, dials, and displays are shown as having round or circular faces. These dial faces may also be square, rectangular or any other shapes. Moreover, the instrument cluster 11 may have any other geometrical or arrangement of the dials.

The information display assembly 10 is adapted to be positioned at a forward internal location of the vehicle. As shown in FIG. 1, the information display assembly 10 is shown mounted to a windshield 16 in a fashion akin to an interior rear-view mirror via a support mount 17. A selected location of the information display assembly 10 may be in substantial proximity to a line of sight of the operator. This location of the information display assembly 10 may serve to minimize the adjustment time of the operator's eyes between the road ahead and the instrument cluster when shifting attention from the road ahead to the instrument cluster, and vice-versa. As such, the information display assembly 10 may provide information on a current or stored status of the vehicle via a corresponding signal or signals communicated to the instrument cluster 11 from a controller (not shown) via the electronic wire harness 15.

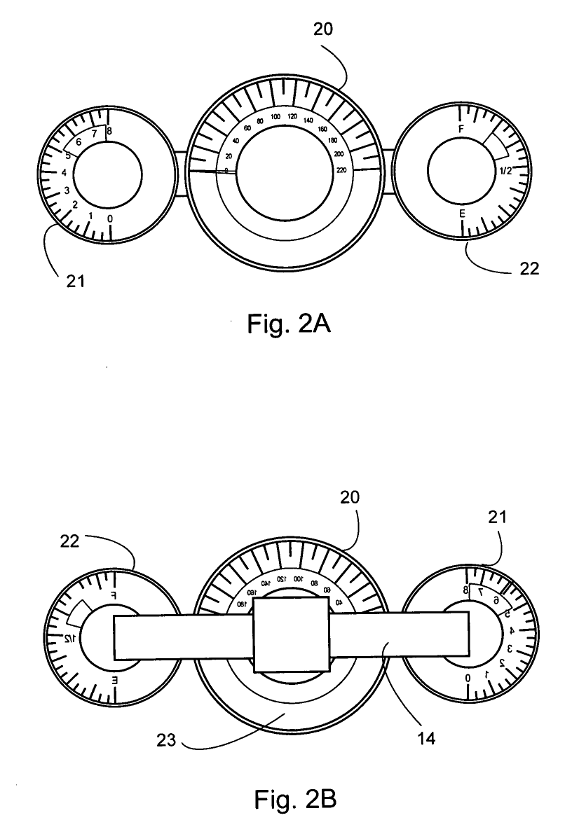

Referring now to FIGS. 2A and 2B, front and back elevational views of the instrument cluster 11 are shown. The instrument cluster 11 is shown as having three displays or gauges (hereinafter “displays”). Although shown with three displays, the instrument cluster 11 may have any number of displays. Of the three displays, the center display 20 illustrates representatively a speedometer, the right display 21 a tachometer, and the left display 22 an engine temperature gauge and a fuel gauge. Each of the three displays 20, 21, and 22 is detachably mounted to back portion 14, via appropriate fasteners. Alternately, instrument cluster 11 may include digital and liquid crystal displays, such as navigational maps or any other available displays chosen by a user.

The instrument cluster 11 may be configured such that displays 20, 21 and 22 are partially transparent through a thickness of their respective geometries so as to minimize an interference with the line of sight of the operator. As such, in addition to plastic or glass front viewing covers, the transparent displays 20, 21 and 22 may include sheets of transparent material covering a corresponding central back opening of the displays 20, 21 and 22. The transparent material may also be plastic or glass.

The displays 20, 21, and 22 can be illuminated so as to be visible and readable in the dark, during night driving for example. The illumination of the displays 20, 21 and 22 may be provided via a light source (not shown), such as a light bulb or other means, provided through or in a radial side or edge opening (not shown) of the display housing or a central opening (not shown) of a back cover 23. Light emitted by the light source travels in the respective display 20, 21 and 22, and may be reflected throughout the interior of the respective display 20, 21 and 22.

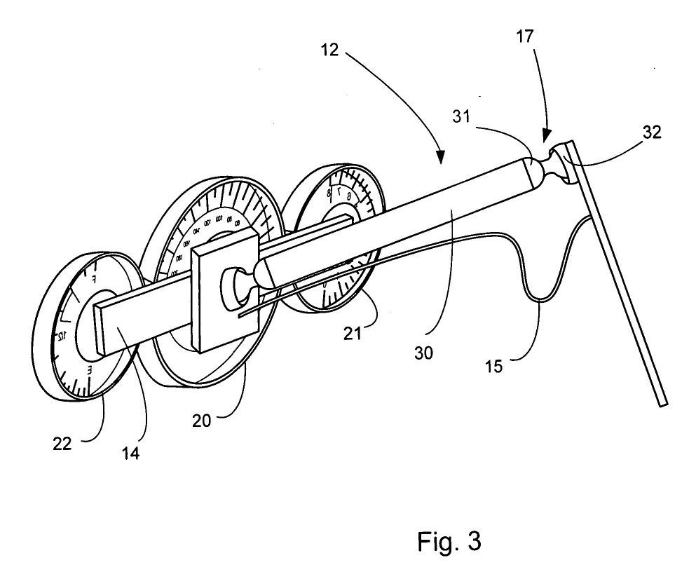

Referring now to FIG. 3, a side elevational view of a mounting unit 12 is shown. The mounting unit 12 has an arm portion 30 adapted to be rigidly or pivotally connected at one end to the back portion 14 (not shown). The arm portion 30 may be pivotally mounted via a base or end portion 31 to a pivotal mount 32 of the support mount 17 in a ball-in-knuckle or ball and socket joint fashion with sufficient friction and/or tension that may allow the instrument cluster 11 to be adjusted by the operator to a given viewing angle position, and to hold that position until re-adjusted by the operator. In other words, pivotal mount 32 may enable the operator to re-orient the information display assembly 10 for optimal viewing similar to a rear-view mirror.

The support mount 17 is adapted to be easily be mounted or installed and relocated onto an alternate location of the windshield 16 as shown in FIG. 1. Such ease of installation and relocation of the support mount 17 can be obtained via the appropriate use of well-known adhesives.

Alternately, the support mount 17 may be positioned in proximity of one of four edges of a frame pillar (not shown) of front windshield 16. A left edge or a right edge, the A-pillar, of windshield 16 may be particularly of interest to racing enthusiasts. Support mount 17 may be mounted to trim covers (not shown) of any of the four edges of windshield 16. The trim covers are typically made of a plastic material, but may be metal or any other suitable material. Moreover, instrument cluster 11 may be located on the exterior of the vehicle. As such, support mount 17 may be mounted externally to the A-pillar, an engine hood or a cowl (not shown).

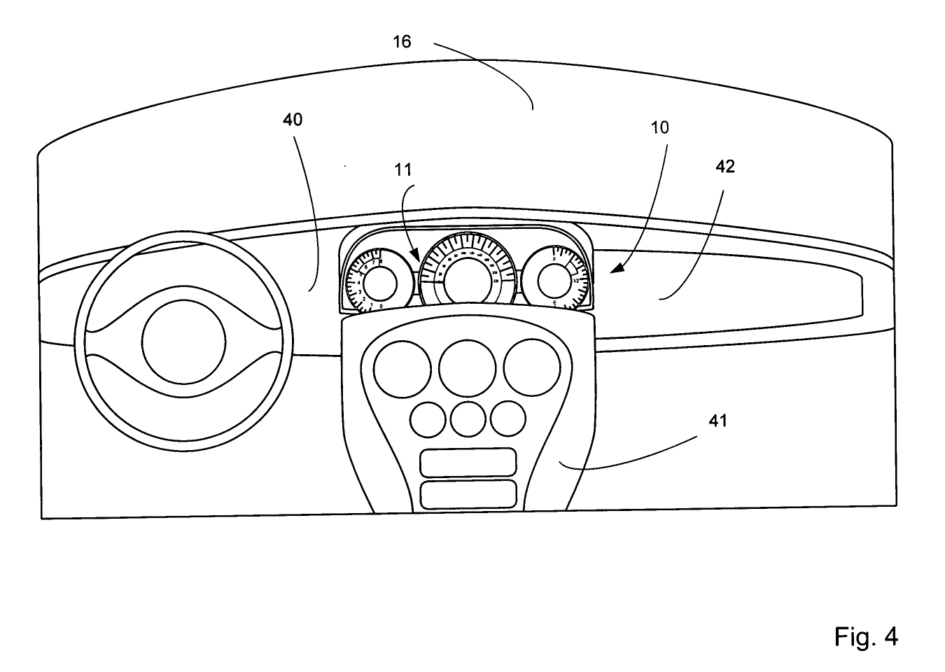

Now referring to FIG. 4, another embodiment of the information display assembly 10 is shown. In FIG. 4, the instrument cluster 11 may be mounted directly on an instrument panel 40 of the vehicle or on a top surface of a center console 41. Such location of the instrument cluster 11 may serve to minimize the adjustment time of the operator's eyes between the road ahead and the instrument cluster when shifting attention from the road ahead to the instrument cluster, and vice-versa.

Alternately, a housing 42 may be provided to embed the instrument cluster 11 on the top surface of the center console 41, to create a fluid visual continuity between the instrument panel 40 and the center console 41, for example. The housing 42 and the information display assembly 10 may be manufactured as separate parts or as integral unit. In either manufactured situation, the information display assembly 10 remains versatile and is able to accept various combinations of displays that individually indicate or emphasize particular vehicle parameters. The information display assembly 10 may be altered or recombined by acquiring alternate displays.

As discussed above in regard to positioning instrument cluster 11 onto the exterior of the vehicle, an external housing (not show) may also be provided to embed instrument cluster 11 on the top of the engine hood, cowl or a-pillar to create either a fluid visual continuity or contrasting image between the instrument panel 11 and the exterior of the vehicle. The external housing and the information display assembly 10 may be manufactured as separate parts or as integral unit. In either manufactured situation, the information display assembly 10 remains versatile and is able to accept various combinations of displays that individually indicate or emphasize particular vehicle parameters. The information display assembly 10 may be altered or recombined by acquiring alternate post-manufacturing displays. Moreover, car enthusiasts may seek customized external instrumentation and corresponding housing so as to emphasize vehicle's designs.

Accordingly, improved space economizing support for information displays visible by the operator and passengers in the vehicle is provided. The mounting units introduced are provided with ease of manufacture, service or alteration of the displays. Moreover, the operator or user may reposition information displays to the vehicle's windshield or instrument panel and to re-orient them for optimal viewing.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

We claim:

1. An information display assembly for an automotive vehicle, the information display assembly comprising:
an instrument cluster; and
a mounting unit, the mounting unit supporting the instrument cluster in a forward internal location of the vehicle, the internal location selectable by an operator.

2. The information display assembly of claim 1, wherein the instrument cluster is orientable with respect to the mounting unit for optimal viewing by the operator.

3. The information display assembly of claim 1, wherein the mounting unit comprises a ball and socket joint.

4. The information display assembly of claim 3, wherein the ball and socket joint is adjustable for a selectable viewing angle of the instrument cluster.

5. The information display assembly of claim 3, wherein the ball and socket joint is configured with an appropriate friction engagement to hold the adjusted position of the instrument cluster until readjusted by the operator.

6. The information display assembly of claim 1, wherein the mounting unit is detachably mounted to the selected forward interior location of the vehicle.

7. The information display assembly of claim 1, wherein the selected forward interior location of the vehicle is on a windshield.

8. The information display assembly of claim 7, wherein the selected forward interior location of the vehicle is a top surface of an instrument panel.

9. The information display assembly of claim 1, wherein the selected forward interior location of the vehicle is one of four sides of a windshield support.

10. The information display assembly of claim 9, wherein the one of four sides of the windshield support is an A-pillar.

11. The information display assembly of claim 10, wherein the instrument cluster displays information indicative of a status of the vehicle, the status of the vehicle being received via a corresponding signal or signals communicated to the instrument cluster via an electronic and electronic wire harness.

12. The information display assembly of claim 1, wherein the instrument cluster includes a dial, a gauge or a display.

13. The information display assembly of claim 1, wherein the instrument cluster includes at least one display instrument that is a fuel gauge, an oil pressure gauge, an engine temperature gauge, a speedometer, a tachometer, and a display for navigational maps.

14. The information display assembly of claim 13, further comprising a light source for the at least one display instrument of the instrument cluster.

15. An information display assembly for an automotive vehicle, the information display comprising:
an instrument cluster including at least one information displaying device; and
a mounting unit coupled to the instrument cluster at a forward interior location of the vehicle, the mounting unit including a mounting base adapted to be detachably affixed to a portion of the vehicle selected by an operator,
wherein the at least one information displaying device is partially transparent, to minimize an interference with a line of sight of the operator.

16. The information display assembly of claim 15, wherein the transparent displaying device has a front viewing cover of plastic or glass.

17. The information display assembly of claim 15, wherein the transparent displaying device has a back cover of plastic or glass.
